(19) United States
(12) Patent Application Publication
(10) Pub. No.: US 2024/0142834 A1
(43) Pub. Date: May 2, 2024

(54) ELECTRO-OPTICAL DEVICE AND ELECTRONIC APPARATUS

(71) Applicant: SEIKO EPSON CORPORATION, Tokyo (JP)

(72) Inventor: Takafumi EGAMI, ENIWA-SHI (JP)

(73) Assignee: SEIKO EPSON CORPORATION, Tokyo (JP)

(21) Appl. No.: 18/496,902

(22) Filed: Oct. 29, 2023

(30) Foreign Application Priority Data
Oct. 31, 2022 (JP) 2022-174340

(51) Int. Cl. G02F 1/1362; G02F 1/1368

(52) U.S. Cl. CPC G02F 1/136209; G02F 1/136286; G02F 1/1368

(57) ABSTRACT

An electro-optical device includes a substrate; a transistor including a semiconductor layer and a gate electrode, the semiconductor layer including a drain region to which a pixel potential is applied and extending in a first direction; a scanning line electrically coupled to the gate electrode; a first insulating layer disposed between the scanning line and the gate electrode; and a light-blocking part with a light-blocking property. The semiconductor layer, the gate electrode, the first insulating layer, and the scanning line are arranged in this order from the substrate. The light-blocking part surrounds the semiconductor layer as viewed in the first direction. The light-blocking part includes a first portion disposed at the first insulating layer. The pixel potential is applied to the light-blocking part.

The present application is based on, and claims priority from JP Application Serial Number 2022-174340, filed Oct. 31, 2022, the disclosure of which is hereby incorporated by reference herein in its entirety.

### BACKGROUND

### 1. Technical Field

The present disclosure relates to an electro-optical device and an electronic apparatus.

### 2. Related Art

Electro-optical devices such as liquid crystal display devices in which optical characteristics can be changed for each pixel are used for electronic apparatuses such as projectors, for example. The electro-optical device disclosed in JP-A-2020-160208 is known as an example of electro-optical devices.

The electro-optical device disclosed in JP-A-2020-160208 includes an element substrate, an opposing substrate, and an electro-optical layer such as a liquid crystal layer disposed between the substrates. The element substrate includes a plurality of pixel electrodes, a transistor electrically coupled to the plurality of pixel electrodes, and a scanning line electrically coupled to the gate electrode of the transistor.

In JP-A-2020-160208, the scanning line is disposed at an upper layer of the gate electrode, and a first light-blocking layer of a constant potential Vcom is disposed at the layer between the gate electrode and the scanning line. Further, a light-blocking part electrically coupled to the first light-blocking layer is provided to cover a part of a semiconductor layer of the transistor from the width direction. Such first light-blocking layer and light-blocking part block the light that is about to enter the incident semiconductor layer. In addition, since the constant potential Vcom is applied to the first light-blocking layer and the light-blocking part, the semiconductor layer is less affected by the potential of the scanning line.

However, since the constant potential Vcom is applied to the first light-blocking layer and the light-blocking part, the potential of the first light-blocking layer and the light-blocking part is different from the potential of the semiconductor layer. In this manner, it is necessary to separate the semiconductor layer, and the first light-blocking layer and the light-blocking part, by a given distance. Since this distance is required, it is difficult to improve the light-blocking property of the semiconductor layer. Therefore, it is desirable to improve the light-blocking property against the light incident on the semiconductor layer while suppressing the influence of the potential of the scanning line on the semiconductor layer.

### SUMMARY

An electro-optical device according to an aspect of the present disclosure includes a substrate, a transistor including a semiconductor layer and a gate electrode, the semiconductor layer including a drain region to which a pixel potential is applied and extending in a first direction, a scanning line electrically coupled to the gate electrode, a first insulating layer disposed between the scanning line and the gate electrode, and a light-blocking part with a light-blocking property, wherein the semiconductor layer, the gate electrode, the first insulating layer, and the scanning line are arranged in this order from the substrate, the light-blocking part surrounds the semiconductor layer as viewed in the first direction, the light-blocking part includes a first portion disposed at the first insulating layer, and the pixel potential is applied to the light-blocking part.

### BRIEF DESCRIPTION OF THE DRAWINGS

FIG. 1 is a plan view of an electro-optical device according to an embodiment.

FIG. 2 is a sectional view of the electro-optical device illustrated in FIG. 1 taken along a line A-A.

FIG. 3 is an equivalent circuit diagram illustrating an electrical configuration of an element substrate of FIG. 1.

FIG. 4 illustrates a part of the element substrate in the display region of FIG. 2.

FIG. 5 is a sectional view taken along a line A1-A1 in FIG. 2.

FIG. 6 is a sectional view taken along a line A2-A2.

FIG. 7 is a plan view of a fourth portion of a light-blocking part illustrated in FIG. 5.

FIG. 8 is a plan view of two first lower conductive parts illustrated in FIG. 5 and a second lower conductive part illustrated in FIG. 6.

FIG. 9 is a plan view of a semiconductor layer illustrated in FIG. 6.

FIG. 10 is a plan view of a first upper conductive part illustrated in FIG. 5 and a second upper conductive part illustrated in FIG. 6.

FIG. 11 is a plan view of a first portion of the light-blocking part illustrated in FIG. 5.

FIG. 12 is a cross-sectional perspective view illustrating a part of the light-blocking part illustrated in FIG. 5.

FIG. 13 is a plan view of a scanning line illustrated in FIG. 6.

FIG. 14 is a plan view of a pixel relay electrode illustrated in FIG. 6.

FIG. 15 is a plan view of a signal line illustrated in FIG. 6.

FIG. 16 is a perspective view illustrating a personal computer as an example of an electronic apparatus.

FIG. 17 is a plan view illustrating a smartphone as an example of the electronic apparatus.

FIG. 18 is a schematic view illustrating a projector as an example of the electronic apparatus.

### DESCRIPTION OF EMBODIMENTS

Preferred embodiments according to the present disclosure are described below with reference to the attached drawings. Note that in the drawing the dimension or scale of each part may differ from the actual one as appropriate, and some parts are schematically illustrated for ease of understanding. The scope of the invention is not limited to these forms, unless otherwise stated in the following description to limit the disclosure.

1. Electro-Optical Device

1A. Basic Configuration

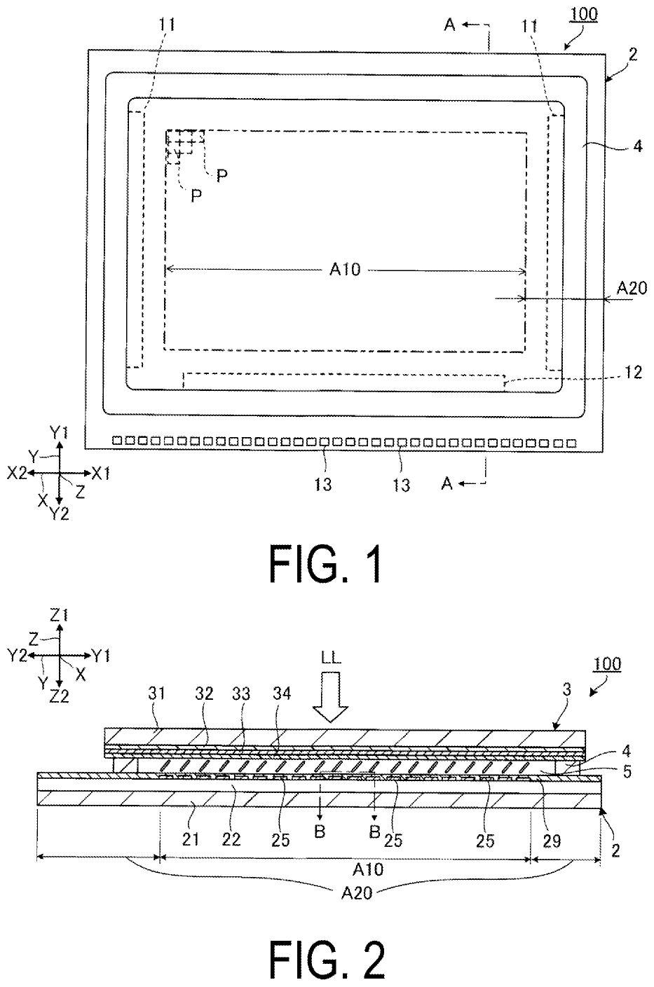

FIG. 1 is a plan view of an electro-optical device 100 according to the embodiment. FIG. 2 is a sectional view of the electro-optical device 100 illustrated in FIG. 1 taken along a line A-A. Note that in FIG. 1, illustration of an opposing substrate 3 is omitted. In addition, the X axis, Y axis, and Z axis orthogonal to one another are used as necessary in the following description for convenience of description. In addition, one direction along the X axis is denoted as X1 direction, and the direction opposite to the X1 direction is denoted as X2 direction. Likewise, one direction along the Y axis is denoted as Y1 direction, and the direction opposite to the Y1 direction is denoted as Y2 direction. One direction along the Z axis is denoted as Z1 direction, and the direction opposite to the Z1 direction is denoted as Z2 direction. In addition, the Y1 direction or the Y2 direction is an example of the “first direction”.

In addition, in this specification, “an element β on an element α” means that the element β is located on the upper side of the element α. Therefore, “an element β on an element α” includes not only a case where the element β is in direct contact with element α, but also a case where the element α and the element β are separated from each other. In addition, “electrical coupling” between the element α and the element β includes not only a configuration where the element α and the element β conduct by being directly joined to each other, but also a configuration where the element α and the element β indirectly conduct through another conductive material.

The electro-optical device 100 illustrated in FIGS. 1 and 2 is a transmissive electro-optical device of an active matrix driving type. As illustrated in FIG. 2, the electro-optical device 100 includes an element substrate 2, the opposing substrate 3, a frame-shaped sealing member 4, and a liquid crystal layer 5. As illustrated in FIG. 2, the element substrate 2, the liquid crystal layer 5 and the opposing substrate 3 are arranged in this order in the Z1 direction. Note that the viewing from their overlapping direction, namely the Z1 direction or the Z2 direction, is referred to as “plan view”. In addition, the shape of the electro-optical device 100 illustrated in FIG. 1 in plan view is quadrangle, but may be polygons other than quadrangle, or circles.

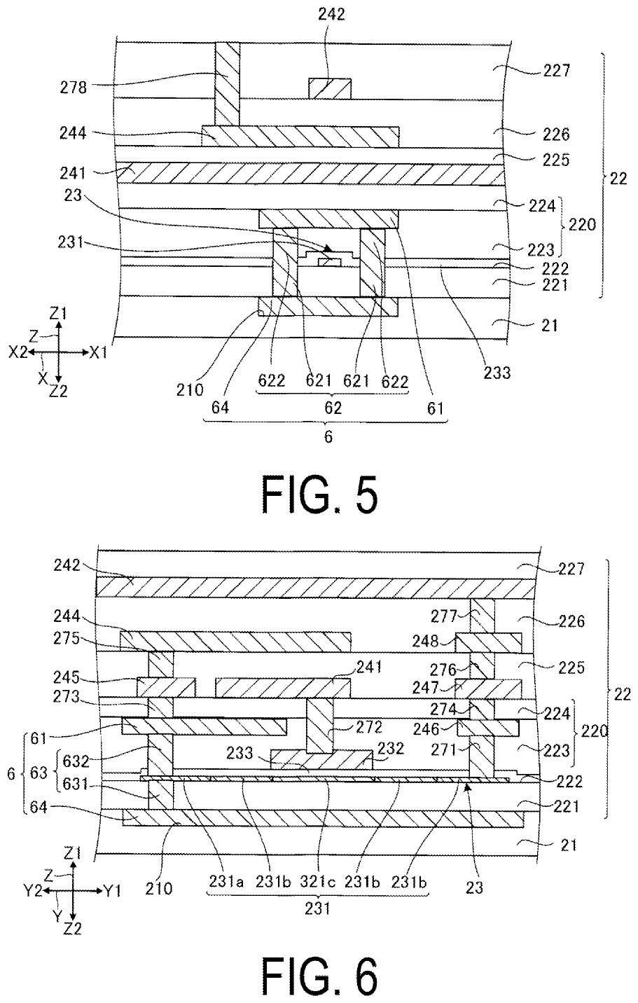

The element substrate 2 illustrated in FIG. 2 includes a first substrate 21 having a light-transmitting property, a layered body 22 having a light-transmitting property, a plurality of pixel electrodes 25 having a light-transmitting property, and a first orientation film 29 having a light-transmitting property. The first substrate 21, the layered body 22, the plurality of pixel electrodes 25, and the first orientation film 29 are layered in this order in the Z1 direction. Note that the “light-transmitting property” means transmissivity with respect to visible light, and may mean a transmittance of visible light of 50% or greater. In addition, as will be described later in detail, the element substrate 2 includes a light-blocking part 6 having a light-blocking property illustrated in FIGS. 5 and 6. Note that “light-blocking property” means a light-blocking property to visible light, may mean a transmittance to visible light of smaller than 50%, and may mean a transmittance to visible light of 10% or smaller.

The first substrate 21 corresponds to “substrate”. The first substrate 21 is a flat plate having a light-transmitting property and an insulating property, and is composed of a glass substrate or a quartz substrate, for example. The layered body 22 includes a plurality of insulating films having a light-transmitting property. In addition, the layered body 22 is provided with various wiring lines and the like. The pixel electrode 25 is used for applying an electric field to the liquid crystal layer 5. The pixel electrode 25 includes a transparent conductive material such as indium tin oxide (ITO), indium zinc oxide (IZO), and fluorine-doped tin oxide (FTO). Note that although not illustrated in the drawings, the element substrate 2 includes a plurality of dummy pixel electrodes surrounding the plurality of pixel electrodes 25 in plan view. In addition, the first orientation film 29 has a light-transmitting property and an insulating property. The first orientation film 29 aligns liquid crystal molecules in the liquid crystal layer 5. The first orientation film 29 is disposed to cover the plurality of pixel electrodes 25. The material of the first orientation film 29 is polyimide, silicon oxide and the like, for example.

The opposing substrate 3 is disposed opposite to the element substrate 2. The opposing substrate 3 includes a second substrate 31 having a light-transmitting property, an inorganic insulating layer 32 having a light-transmitting property, a common electrode 33 having a light-transmitting property, and a second orientation film 34 having a light-transmitting property. In addition, although not illustrated in the drawings, the opposing substrate 3 includes a light-blocking parting that surrounds the plurality of pixel electrodes 25 in plan view.

The second substrate 31, the inorganic insulating layer 32, the common electrode 33, and the second orientation film 34 are layered in this order in the Z2 direction. The second substrate 31 is a flat plate having a light-transmitting property and an insulating property, and is composed of a glass substrate or a quartz substrate, for example. The inorganic insulating layer 32 has a light-transmitting property and an insulating property, and is made of an inorganic material containing silicon such as silicon oxide, for example. The common electrode 33 is an opposing electrode disposed opposite to the plurality of pixel electrodes 25 through the liquid crystal layer 5. The common electrode 33 is used for applying an electric field to the liquid crystal layer 5. The common electrode 33 has a light-transmitting property and conductivity. The common electrode 33 includes a transparent conductive material such as ITO, IZO and FTO. The second orientation film 34 has a light-transmitting property and an insulating property. The second orientation film 34 aligns liquid crystal molecules in the liquid crystal layer 5. The material of the second orientation film 34 is polyimide, silicon oxide and the like, for example.

The sealing member 4 is disposed between the element substrate 2 and the opposing substrate 3. The sealing member 4 is formed by using an adhesive agent including various curable resins such as epoxy resins, or the like. The sealing member 4 may include a gap material composed of an inorganic material such as glass.

The liquid crystal layer 5 is disposed in a region surrounded by the element substrate 2, the opposing substrate 3, and the sealing member 4. The liquid crystal layer 5 is an electro-optical layer with optical characteristics that change in accordance with the electric field. The liquid crystal layer 5 contains liquid crystal molecules with positive or negative dielectric anisotropy. The orientation of the liquid crystal molecules changes in accordance with the voltage applied to the liquid crystal layer 5.

As illustrated in FIG. 1, a plurality of scanning line driving circuits 11, a signal line driving circuit 12 and a plurality of external terminals 13 are disposed at the element substrate 2. Some of the plurality of external terminals 13 are coupled with a wiring line drawn from the scanning line driving circuit 11 or the signal line driving circuit 12 although not illustrated in the drawings. In addition, the plurality of external terminals 13 includes a terminal to which a constant potential Vcom is applied. The terminal is electrically coupled to the common electrode 33 of the opposing substrate 3 through a wiring line and a conductive material (not illustrated). In this manner, the constant potential Vcom is supplied to the common electrode 33.

The electro-optical device 100 includes a display region A10 that displays images, and a peripheral region A20 located outside the display region A10 in plan view. A plurality of pixels P arranged in a matrix is provided in the display region A10. The plurality of pixel electrodes 25 is disposed in a one-to-one relationship for the plurality of pixels P. The above-described common electrode 33 is provided commonly to the plurality of pixels P. In addition, the peripheral region A20 surrounds the display region A10 in plan view. The scanning line driving circuit 11 and the signal line driving circuit 12 are disposed in the peripheral region A20.

In this embodiment, the electro-optical device 100 is of a transmissive type. More specifically, as illustrated in FIG. 2, after entering the opposing substrate 3, light LL is modulated before being emitted from the element substrate 2, whereby an image is displayed. Note that light having entered the element substrate 2 may be modulated before being emitted from the opposing substrate 3, whereby an image is displayed.

In addition, the electro-optical device 100 is applied to display devices that perform color display such as personal computers and smartphones to be described later, for example. When applied to the display device, a color filter is used for the electro-optical device 100 as necessary. In addition, the electro-optical device 100 is applied to projection-type projectors to be described later. In this case, the electro-optical device 100 functions as a light valve. Note that in this case, the color filter is omitted for the electro-optical device 100.

1B. Electrical Configuration of Element Substrate 2

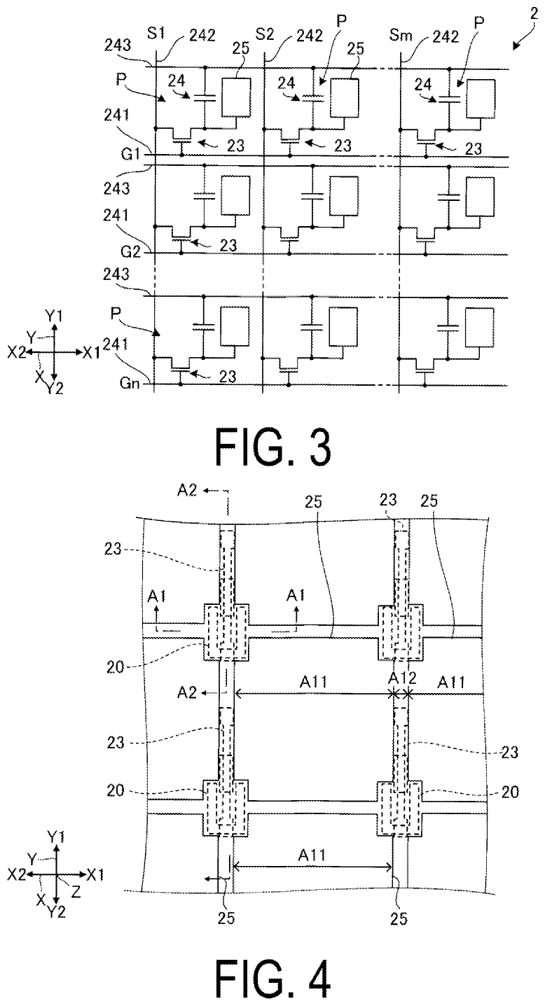

FIG. 3 is an equivalent circuit diagram illustrating an electrical configuration of the element substrate 2 of FIG. 1. As illustrated in FIG. 3, the element substrate 2 includes a plurality of transistors 23, n scanning lines 241, m signal lines 242 and n constant potential lines 243. The n and m are each an integer of 2 or greater. The transistor 23 is disposed in a manner corresponding to each intersection of the n scanning lines 241 and the m signal lines 242. Each transistor 23 is a thin film transistor (TFT) that functions as a switching element, for example. Each transistor 23 includes a gate, a source, and a drain.

The n scanning lines 241 are extended in the X1 direction, and the n scanning lines 241 are arranged at even intervals in the Y1 direction. The n scanning lines 241 are respectively electrically coupled to the gates of the plurality of corresponding transistors 23. The n scanning lines 241 is electrically coupled to the scanning line driving circuit 11 illustrated in FIG. 1. Scanning signals G1, G2 . . . and Gn are line-sequentially supplied to one to n scanning lines 241 from the scanning line driving circuit 11.

The m signal lines 242 illustrated in FIG. 3 are extended in the Y1 direction, and the m signal lines 242 are arranged at even intervals in the X1 direction. The m signal lines 242 are respectively electrically coupled to the sources of the plurality of corresponding transistors 23. The m signal lines 242 are electrically coupled to the signal line driving circuit 12 illustrated in FIG. 1. Image signals S1, S2 . . . and Sm are supplied in parallel to one to m signal lines 242 from the signal line driving circuit 12.

The n scanning lines 241 and the m signal lines 242 illustrated in FIG. 3 are electrically isolated from each other, and disposed in a grid form in plan view. The region surrounded by adjacent two scanning lines 241 and adjacent two signal lines 242 corresponds to a pixel P. The transistor 23, the pixel electrode 25 and a capacitive element 24 are provided for each pixel P. The pixel electrode 25 is provided in a one-to-one relationship for the transistor 23. Each pixel electrode 25 is electrically coupled to the drain of the corresponding transistor 23.

The n constant potential lines 243 are extended in the X1 direction, and the n constant potential lines 243 are arranged at even intervals in the Y2 direction. In addition, the n constant potential lines 243 are electrically isolated from the n scanning lines 241 and the m signal lines 242, and are disposed with a space therebetween. The constant potential Vcom is applied to each constant potential line 243. Each of the n constant potential lines 243 is electrically coupled to one of the two electrodes of the corresponding capacitive element 24. Each capacitive element 24 is a capacitive element for holding the potential of the pixel electrode 25. The capacitive element 24 is provided in a one-to-one relationship for the transistor 23. In addition, the other of the two electrodes of each capacitive element 24 is electrically coupled to the corresponding pixel electrode 25. Therefore, the constant potential Vcom is applied to one electrode of the capacitive element 24, and the other electrode is electrically coupled to the drain of the transistor 23.

When the scanning signals G1, G2 . . . and Gn sequentially become active and the n scanning lines 241 are sequentially selected, the transistor 23 coupled with the selected scanning line 241 is turned on. Then, the image signals S1, S2 . . . and Sm with values corresponding to the gradation to be displayed through the m signal lines 242 are taken by the pixel P corresponding to the selected scanning line 241, and applied to the pixel electrode 25. In this manner, the voltage corresponding to the gradation to be displayed is applied to the liquid crystal capacitance formed between the pixel electrode 25 and the common electrode 33 in FIG. 2, and the orientation of the liquid crystal molecules changes in accordance with the applied voltage. In addition, the applied voltage is held by the capacitive element 24. Such a change of the orientation of the liquid crystal molecules modulates the light and achieves gradation display.

1C. Structure of Part of Element Substrate 2

FIG. 4 illustrates a part of the element substrate 2 in the display region A10 of FIG. 2. As illustrated in FIG. 4, the display region A10 includes a plurality of opening regions A11, and a light-blocking region A12. The plurality of opening regions A11 is disposed in a matrix in plan view. The shape of the light-blocking region A12 in plan view is a frame shape located between the plurality of opening regions A11. Each opening region A11 is a region where the pixel electrode 25 is disposed, and is a portion through which light is transmitted. On the other hand, the transistor 23 is disposed in the light-blocking region A12. In addition, although not illustrated in FIG. 4, various wiring lines such as the scanning line 241, the signal line 242 and the constant potential line 243, and the capacitive element 24 illustrated in FIG. 3 are disposed in the light-blocking region A12.

FIG. 5 is a sectional view taken along a line A1-A1 in FIG. 2. FIG. 6 is a sectional view taken along a line A2-A2. As illustrated in FIGS. 5 and 6, the element substrate 2 includes the first substrate 21 as “substrate”, the layered body 22, and the light-blocking part 6. The layered body 22 includes a plurality of insulating films 221, 222, 223, 224, 225, 226 and 227. The insulating films 221, 222, 223, 224, 225, 226, and 227 are layered in this order from the first substrate 21. In addition, the insulating films 223 and 224 make up an insulating layer 220. The insulating films 221 to 227 have a light-transmitting property and an insulating property. Each material of the insulating films 221 to 227 is an inorganic material containing silicon such as silicon oxide and silicon oxynitride, for example.

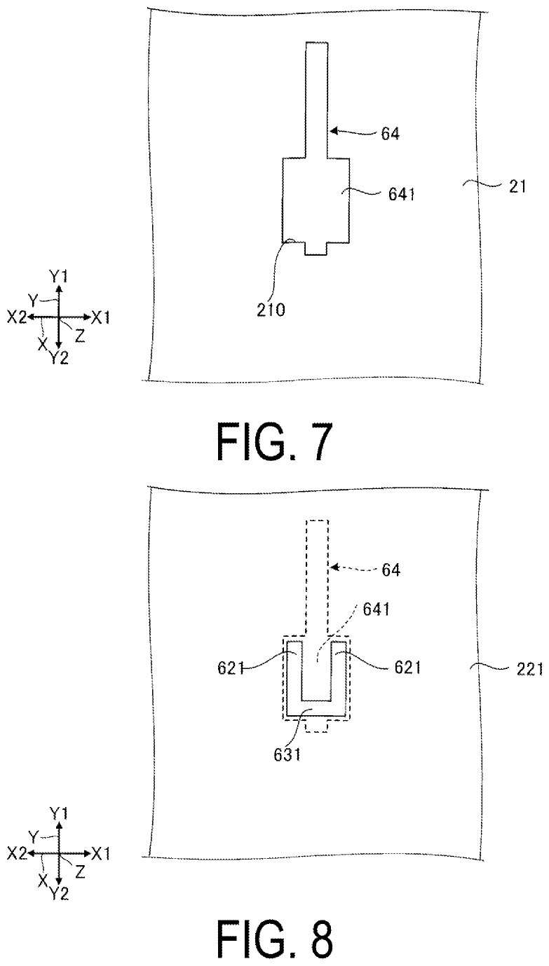

The transistor 23, the scanning line 241, the signal line 242, and the light-blocking part 6 are disposed at the layered body 22. Further, a pixel relay electrode 244, and relay electrodes 245, 246, 247 and 248 are disposed at the layered body 22. The element substrate 2 is described below with reference to FIGS. 5 and 6 and by using FIGS. 7 to 15 to be described later.

As described above, the first substrate 21 illustrated in FIGS. 5 and 6 is composed of a glass substrate or a quartz substrate, for example. The first substrate 21 includes a recess 210. The recess 210 is a depression formed in the first substrate 21, and formed for each transistor 23. The recess 210 is formed along the Y1 direction, which is the extending direction of a semiconductor layer 231 to be described later. The recess 210 is formed by a damascene method.

A part of the light-blocking part 6 is disposed in the recess 210. The light-blocking part 6 is provided for preventing the entry of light into the semiconductor layer 231 of the transistor 23. The light-blocking part 6 includes a first portion 61, two second portions 62, a third portion 63, and a fourth portion 64. Each second portion 62 includes a first lower conductive part 621 and a first upper conductive part 622. The third portion 63 includes a second lower conductive part 631 and a second upper conductive part 632. The fourth portion 64 is disposed in the recess 210.

FIG. 7 is a plan view of the fourth portion 64 of the light-blocking part 6 illustrated in FIG. 5. In plan view, the fourth portion 64 extends in the Y1 direction and includes a wide portion 641 in the middle portion. With the fourth portion 64 provided in the recess 210, peeling of the fourth portion 64 from the first substrate 21 and warp of the first substrate 21 can be suppressed in comparison with the case where the fourth portion 64 is provided to protrude from the first substrate 21. Note that the recess 210 may not be provided in the first substrate 21, and the fourth portion 64 may be provided to protrude from the flat top surface of the first substrate 21.

As illustrated in FIG. 5, the first lower conductive part 621 of each second portion 62 of the light-blocking part 6 is provided at the insulating film 221. In addition, as illustrated in FIG. 6, the second lower conductive part 631 of the third portion 63 is provided at the insulating film 221. The first lower conductive part 621 and the second lower conductive part 631 are disposed in a through hole formed in the insulating film 221. The first lower conductive part 621 and the second lower conductive part 631 are joined to the fourth portion 64.

FIG. 8 is a plan view of the first lower conductive part 621 illustrated in FIG. 5 and the second lower conductive part 631 illustrated in FIG. 6. As illustrated in FIG. 8, two first lower conductive parts 621 and the second lower conductive part 631 are integrally formed. Each of the two first lower conductive parts 621 extends along the Y1 direction in plan view. The second lower conductive part 631 extends in the X1 direction in plan view, located between the two first lower conductive parts 621, and coupled to the two first lower conductive parts 621. In addition, the two first lower conductive parts 621 and the second lower conductive part 631 overlap the wide portion 641 of the fourth portion 64 in plan view.

As illustrated in FIGS. 5 and 6, the transistor 23 is disposed on the insulating film 221. The transistor 23 includes the semiconductor layer 231, a gate electrode 232, and a gate insulating film 233. The semiconductor layer 231 is disposed on the insulating film 221, and the gate electrode 232 is disposed on an insulating film 222. The gate insulating film 233 is interposed between the gate electrode 232 and a channel region 231c of the semiconductor layer 231. The region corresponding to the gate electrode 232 in the insulating film 222 corresponds to the gate insulating film 233.

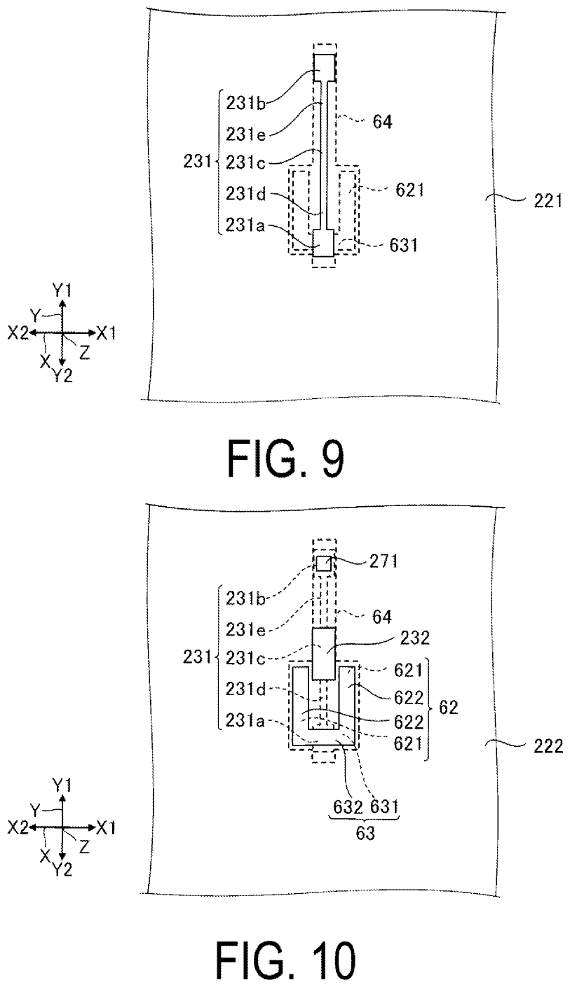

FIG. 9 is a plan view of the semiconductor layer 231 illustrated in FIG. 6. The semiconductor layer 231 has a lightly doped drain (LDD) structure. More specifically, the semiconductor layer 231 includes a drain region 231a, a source region 231b, the channel region 231c, a low-concentration drain region 231d and a low-concentration source region 231e. The channel region 231c is located between the drain region 231a and the source region 231b. The low-concentration drain region 231d is located between the channel region 231c and the drain region 231a. The low-concentration source region 231e is located between the channel region 231c and the source region 231b. The semiconductor layer 231 is made of polysilicon, for example. The region excluding the channel region 231c is doped with impurities that increase conductivity. The impurity concentration in the low-concentration drain region 231d is lower than the impurity concentration in the drain region 231a. The impurity concentration in the low-concentration source region 231e is lower than the impurity concentration in the source region 231b. Note that the low-concentration source region 231e may be omitted, for example.

The semiconductor layer 231 extends in the Y1 direction in plan view as with the fourth portion 64, and overlaps the fourth portion 64. In addition, the drain region 231a overlaps the second lower conductive part 631 of the third portion 63 in plan view. In addition, in plan view, the two first lower conductive parts 621 of the second portion 62 separated from the low-concentration drain region 231d are provided on both sides of the low-concentration drain region 231d. In other words, in plan view, the low-concentration drain region 231d is provided between the two first lower conductive parts 621 with a space therebetween.

The gate electrode 232 illustrated in FIG. 6 is made of polysilicon doped with impurities that increase conductivity, for example. Note that the gate electrode 232 may be made of conductive materials of metals, metal oxides, and metal compounds. In addition, the gate insulating film 233 is composed of a silicon oxide film deposited by a heat oxidation or chemical vapor deposition (CVD) method or the like film.

As illustrated in FIG. 5, the first upper conductive part 622 of the second portion 62 is disposed at the insulating films 222 and 223. In addition, as illustrated in FIG. 6, the second upper conductive part 632 of the third portion 63 is disposed at the insulating films 222 and 223.

FIG. 10 is a plan view of the first upper conductive part 622 illustrated in FIG. 5 and the second upper conductive part 632 illustrated in FIG. 6. As illustrated in FIG. 10, the two first upper conductive parts 622 and the second upper conductive part 632 are integrally formed. The two first upper conductive parts 622 extend along the Y1 direction in plan view. The two first upper conductive parts 622 overlap the two first lower conductive parts 621 in plan view. In addition, the second upper conductive part 632 is extended in the X1 direction in plan view, located between the two first upper conductive parts 622, and coupled to the two first upper conductive parts 622. The second upper conductive part 632 overlaps the second lower conductive part 631 in plan view. In addition, as illustrated in FIG. 10, the above-described gate electrode 232 overlaps the channel region 231c in plan view.

As illustrated in FIG. 5, the first upper conductive part 622 and the first lower conductive part 621 are joined to each other. Likewise, the second upper conductive part 632 and the second lower conductive part 631 are joined to each other. In addition, as illustrated in FIG. 6, the semiconductor layer 231 is disposed between the second upper conductive part 632 and the second lower conductive part 631. More specifically, the drain region 231a is provided between the second upper conductive part 632 and the second lower conductive part 631. Then, the second upper conductive part 632 and the second lower conductive part 631 are joined to the drain region 231a. In this manner, the second portion 62 is electrically coupled to the drain region 231a, and the pixel potential is supplied to the second portion 62.

As illustrated in FIGS. 5 and 6, the first portion 61 of the light-blocking part 6 is disposed at insulating film 223. In other words, the first portion 61 is disposed at the insulating layer 220. The first portion 61 is formed by a damascene method, for example. The scanning line 241 is disposed on the insulating layer 220, and thus the insulating layer 220 is disposed between the scanning line 241 and the gate electrode 232. Thus, the semiconductor layer 231, the gate electrode 232, the insulating layer 220, the scanning line 241, and the first substrate 21 are disposed side by side in this order. In addition, the first portion 61 is joined to two second portions 62 and the third portion 63. In addition, as illustrated in FIG. 6, a relay electrode 246 is disposed on insulating film 223 in addition to the first portion 61. The relay electrode 246 is electrically coupled to the source region 231b of the semiconductor layer 231 through a contact hole 271 extending through the insulating films 222 and 223.

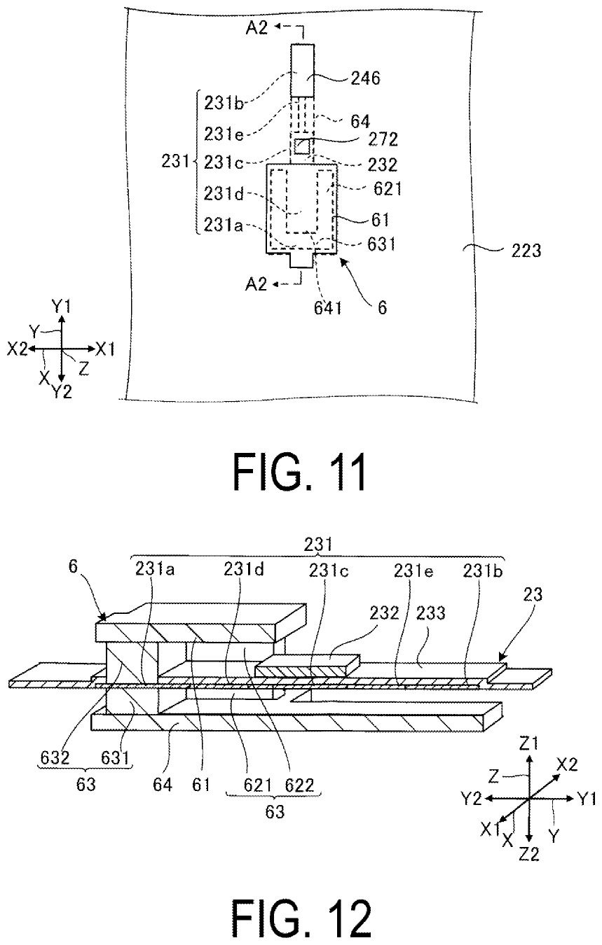

FIG. 11 is a plan view of the first portion 61 of the light-blocking part 6 illustrated in FIG. 5. As illustrated in FIG. 11, the first portion 61 has a substantially quadrangular shape in plan view and overlaps the wide portion 641 of the fourth portion 64. In addition, the first portion 61 overlaps two second portions 62 and the third portion 63 in plan view. In addition, the first portion 61 overlaps the low-concentration drain region 231d and the drain region 231a in plan view.

FIG. 12 is a cross-sectional perspective view illustrating a part of the element substrate 2 illustrated in FIG. 5. As described above, the light-blocking part 6 includes the first portion 61, the two second portions 62, the third portion 63, and the fourth portion 64. As illustrated in FIG. 12, the light-blocking part 6 is provided to cover a part of the semiconductor layer 231. In addition, as illustrated in FIG. 5, the light-blocking part 6 surrounds the semiconductor layer 231 as viewed in the Y1 direction, which is the extending direction of the semiconductor layer 231. By surrounding the semiconductor layer 231 with the light-blocking part 6, incidence of light on the semiconductor layer 231 can be suppressed by the light-blocking part 6. More specifically, in addition to the entry of light in the Z2 direction toward the semiconductor layer 231, the entry of light from a direction other than the Z2 direction due to interface reflection and the like can be suppressed.

In addition, the first portion 61 of the light-blocking part 6 is disposed at the insulating layer 220. That is, the first portion 61 is provided between the scanning line 241 and the gate electrode 232. In this manner, the influence of the potential of the scanning line 241 on the semiconductor layer 231 of the lower layer of the gate electrode 232 can be suppressed. More specifically, the increase in off-leak current due to the gate potential coming closer to the region other than the channel region 231c of the semiconductor layer 231 can be suppressed. In this manner, the reduction in display quality due to the occurrence of black spots and the like can be suppressed. Note that the off-leak current is a leakage current that flows when the transistor 23 is turned off.

Further, the pixel potential is applied to the light-blocking part 6. In this manner, since the light-blocking part 6 is not a gate potential, there is no risk of the influence of the above-described gate potential even when the light-blocking part 6 is disposed near the semiconductor layer 231. In addition, the pixel potential is applied to the light-blocking part 6, and the pixel potential is applied to the drain region 231a of the semiconductor layer 231. Thus, the potential of the light-blocking part 6 and the potential of a part of the semiconductor layer 231 are the same potential. Therefore, defects less occur even when the light-blocking part 6 is brought closer to the semiconductor layer 231, and thus the light-blocking part 6 can be brought closer to the semiconductor layer 231 than in the related art. Thus, the light-blocking property of the semiconductor layer 231 by the light-blocking part 6 can be increased than in the related art. In this manner, the destabilization of the operation of the transistor 23 can be suppressed, and as a result the risk of the occurrence of display defects such as luminance unevenness can be suppressed.

In addition, as described above, the first portion 61 overlaps the low-concentration drain region 231d of semiconductor layer 231 in plan view. In this manner, the influence of the potential of the scanning line 241 on the low-concentration drain region 231d can be suppressed. Therefore, the drain leakage current when the transistor 23 is turned off can be suppressed.

In addition, as described above, the light-blocking part 6 includes the two second portions 62. As illustrated in FIG. 5, the two second portions 62 extend from the first portion 61 toward the first substrate 21, and are located on both sides of the semiconductor layer 231 as viewed in the Y1 direction, respectively. With the two second portions 62 included, the entry of light into the semiconductor layer 231 from the X1 direction and the X2 direction due to interface reflection and the like can be suppressed.

Further, as illustrated in FIG. 6, the light-blocking part 6 includes the third portion 63. The third portion 63 is joined to the drain region 231a. Specifically, the light-blocking part 6 includes a portion electrically coupled to the drain region 231a. In this manner, the light-blocking part 6 is electrically coupled to the drain region 231a, and the pixel potential is supplied to the light-blocking part 6. In addition, since the light-blocking part 6 is directly coupled to the semiconductor layer 231, the distance between the light-blocking part 6 and the semiconductor layer 231 is very smaller than in the related art. Specifically, the light-blocking part 6 has a proximal light-blocking structure in which the distance to the semiconductor layer 231 is small. Thus, the light-blocking property of the light-blocking part 6 can be especially effectively increased. In addition, the third portion 63 extends from the first portion 61 toward the first substrate 21, is located between the two second portions 62 as viewed in the Y1 direction, and is coupled to the two second portions 62. With the first portion 61, the second portion 62 and the third portion 63, the entry of light from the X1 direction, the X2 direction, the Y1 direction and the Z2 direction toward the semiconductor layer 231, especially the low-concentration drain region 231d, can be suppressed.

In addition, the light-blocking part 6 includes the fourth portion 64. The fourth portion 64 is disposed between the first substrate 21 and the semiconductor layer 231. With the fourth portion 64, the entry of light into the semiconductor layer 231 from the Z2 direction can be suppressed. Thus, with the light-blocking part 6 including the first portion 61, the second portion 62, the third portion 63 and the fourth portion 64, the entry of light into the low-concentration drain region 231d from various directions can be blocked.

Examples of the material of the light-blocking part 6 include metals such as tungsten (W), titanium (Ti), chromium (Cr), iron (Fe) and aluminum (Al), metal nitrides and metal silicides, for example. Among them, the light-blocking part 6 may contain tungsten. Among various metals, tungsten is excellent in heat resistance, and its optical density (OD) value does not decrease easily by heat treatment during manufacturing, for example. Thus, with the light-blocking part 6 containing tungsten, the entry of light into the semiconductor layer 231 can be especially effectively prevented by the light-blocking part 6. In addition, the material of each portion of the light-blocking part 6 may be identical to or different from each other.

As illustrated in FIGS. 5 and 6, the scanning line 241 is disposed on an insulating film 224. In addition, as illustrated in FIG. 6, the relay electrodes 245 and 247 are disposed on the insulating film 224. The scanning line 241 is electrically coupled to the gate electrode 232 through a contact hole 272 extending through the insulating layer 220. The relay electrode 245 is electrically coupled to the first portion 61 through a contact hole 273 extending through the insulating film 224. A relay electrode 247 is electrically coupled to the relay electrode 246 through a contact hole 274 extending through the insulating film 224.

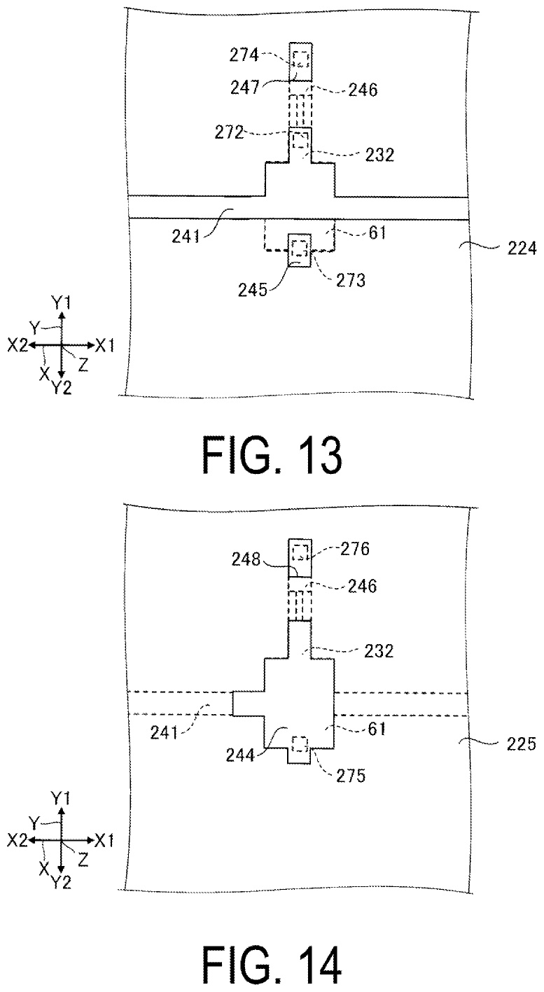

FIG. 13 is a plan view of the scanning line 241 illustrated in FIG. 6. As illustrated in FIG. 13, the scanning line 241 extends in the X1 direction. In addition, the scanning line 241 includes a portion overlapping the gate electrode 232 in plan view to achieve electrical coupling to the gate electrode 232.

As illustrated in FIG. 6, the pixel relay electrode 244 and the relay electrode 248 are disposed on an insulating film 225. The pixel relay electrode 244 is electrically coupled to the relay electrode 245 through a contact hole 275 extending through the insulating film 225. In this manner, the pixel relay electrode 244 is electrically coupled to the drain region 231a. As illustrated in FIG. 5, the pixel relay electrode 244 is electrically coupled to the pixel electrode 25 not illustrated in the drawing through a contact hole 278 extending through the insulating films 226 and 227. In the contact hole 278, a conductive coupling member that electrically couples the pixel relay electrode 244 and the pixel electrode 25 is disposed. The coupling member is a plug made of a metal, for example. The pixel relay electrode 244 is electrically coupled to the pixel electrode 25 and the drain region 231a of the transistor 23 through the coupling member and the like. In addition, the relay electrode 248 is electrically coupled to the relay electrode 247 through a contact hole 276 extending through the insulating film 225.

FIG. 14 is a plan view of the pixel relay electrode 244 illustrated in FIG. 6. As illustrated in FIG. 14, the pixel relay electrode 244 includes a portion overlapping the first portion 61 in plan view, and protruding portions extending in the X2 direction and the Y1 direction from that portion.

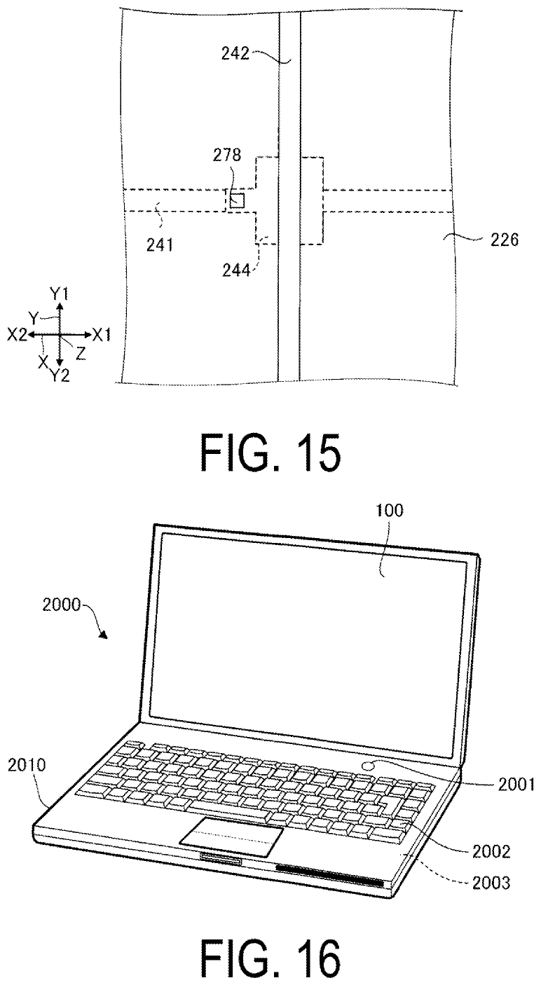

As illustrated in FIG. 6, the signal line 242 is disposed on the insulating film 226. The signal line 242 is electrically coupled to the relay electrode 248 through a contact hole 277 extending through the insulating film 226. FIG. 15 is a plan view of the signal line 242 illustrated in FIG. 6. As illustrated in FIG. 15, the signal line 242 extends along the Y1 direction.

Note that although not illustrated in the drawings, the pixel electrode 25, the capacitive element 24, and the constant potential line 243 are disposed on the upper side of the insulating film 227 illustrated in FIGS. 5 and 6.

In addition, the material of the scanning line 241, the signal line 242, the constant potential line 243, the pixel relay electrode 244, the relay electrodes 245, 246, 247, and 248 described above is not limited, and is composed of a layered body of an aluminum film and a nitride titanium film, for example. With the aluminum film included, a lower resistance can be achieved in comparison with a configuration composed only of a nitride titanium film. Note that each electrode or wiring line may be composed of a material other than the above-described material. For example, each electrode or wiring line may be composed of metals such as tungsten (W), titanium (Ti), chromium (Cr), iron and aluminum (Al), metal nitrides, metal silicides, or the like. In addition, the material of the above-described contact holes 271 to 278 is not limited, and examples of the material include metals such as tungsten, titanium, chromium, iron and aluminum, metal nitrides and metal silicides.

Note that for example, after the contact holes 271 to 278 are formed in the corresponding insulating film, the contact holes 271 to 278 are filled with a metal such as tungsten, and thereafter the surface of the insulating film is formed into a continuous flat surface by chemical mechanical polishing or the like. As a result, the contact holes 271 to 278 are formed as plugs. Note that the contact holes 271 to 278 may be integrally formed with various wiring lines or electrodes formed thereon.

2. Modifications

Embodiments exemplified above may be modified in various manners. Aspects of specific modifications applicable to the above-described embodiments are described below. Two or more aspects freely selected from the following examples may be combined as appropriate to the extent that they are not inconsistent with each other.

While the electro-optical device 100 of an active matrix type is exemplified in the above-described embodiments, this is not limitative, and the driving type of the electro-optical device 100 may be a passive matrix type and the like, for example.

The driving type of “electro-optical device” is not limited to a vertical electric field type, and may be a horizontal electric field type. Note that examples of the horizontal electric field type include an in-plane switching (IPS) mode. In addition, examples of the vertical electric field type include a twisted nematic (TN) mode, a vertical alignment (VA), a PVA mode, and an optically compensated bend (OCB) mode.

While the first portion 61 overlaps the low-concentration drain region 231d and the drain region 231a in plan view in the above description, the first portion 61 may overlap another region.

The third portion 63 is joined to the drain region 231a in the above description. However, it suffices that the light-blocking part 6 is a pixel potential, and the third portion 63 may not be directly coupled to the drain region 231a.

While the fourth portion 64 is disposed inside the recess 210 of the first substrate 21 in the above description, the fourth portion 64 may be disposed at a flat top surface of the first substrate 21. Therefore, the fourth portion 64 may be protruded from the first substrate 21.

3. Electronic Apparatus

The electro-optical device 100 may be used for various electronic apparatuses.

FIG. 16 is a perspective view illustrating a personal computer 2000 as an example of an electronic apparatus. The personal computer 2000 includes the electro-optical device 100 that displays various images, a main body part 2010 where a power switch 2001 and a keyboard 2002 are installed, and a control unit 2003. The control unit 2003 includes a processor and a memory, and controls the operation of the electro-optical device 100, for example.

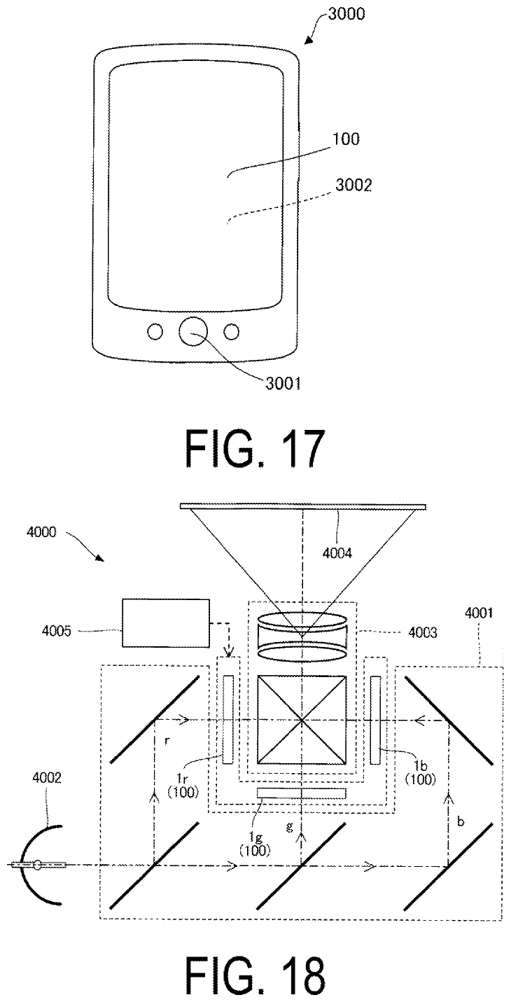

FIG. 17 is a plan view illustrating a smartphone 3000 as an example of the electronic apparatus. The smartphone 3000 includes an operation button 3001, the electro-optical device 100 that displays various images, and a control unit 3002. The screen content displayed on the electro-optical device 100 is changed in accordance with the operation of the operation button 3001. The control unit 3002 includes a processor and a memory, and controls the operation of the electro-optical device 100, for example.

FIG. 18 is a schematic view illustrating a projector as an example of the electronic apparatus. A projection-type display device 4000 is a projector of a three plate type, for example. An electro-optical device 1r is the electro-optical device 100 corresponding to the red display color, an electro-optical device 1g is the electro-optical device 100 corresponding to the green display color, and an electro-optical device 1b is the electro-optical device 100 corresponding to the blue display color. That is, the projection-type display device 4000 includes the three electro-optical devices 1r, 1g and 1b corresponding to red, green, and blue display colors, respectively. A control unit 4005 includes a processor and a memory, and controls the operation of the electro-optical device 100, for example.

Of light emitted from an illumination apparatus 4002 serving as the light source, the illumination optical system 4001 supplies the red component r to the electro-optical device 1r, the green component g to the electro-optical device 1g, and the blue component b to the electro-optical device 1b. Each of the electro-optical devices 1r, 1g and 1b functions as a light modulator such as a light valve that modulates the respective monochromatic light supplied from the illumination optical system 4001 in accordance with the display image. A projection optical system 4003 combines and projects light emitted from each of the electro-optical devices 1r, 1g and 1b to a projection surface 4004.

The above-described electronic apparatus includes the electro-optical device 100, and the control units 2003, 3002, or 4005 described above. The above-described electro-optical device 100 has an excellent light-blocking property because of the light-blocking part 6 of the semiconductor layer 231, and thus the destabilization of the operation of the transistor 23 is suppressed. In this manner, the risk of the occurrence of display defects is suppressed. Thus, with the electro-optical device 100, the display quality of the personal computer 2000, the smartphone 3000, or the projection-type display device 4000 can be increased.

Note that electronic apparatuses to which the electro-optical device of the present disclosure is applied are not limited to the exemplified apparatuses, and examples of the electronic apparatuses to which the electro-optical device of the present disclosure is applied include personal digital assistants (PDA), digital still cameras, televisions, video camcorders, car navigation systems, in-vehicle displays, electronic notebooks, electronic papers, calculators, word processors, workstations, television phones, and point-of-sale (POS) terminals. Further, examples of electronic apparatuses to which the present disclosure is applied include printers, scanners, copiers, video players, or apparatuses including a touch panel.

Hereinabove, the present disclosure has been described based on preferred embodiments, but the present disclosure is not limited to the above-described embodiments. In addition, the configuration of each part of the present disclosure may be replaced with any configuration that exhibits functions similar to those of the above-described embodiment, and any configuration may be added.

In addition, while as a liquid crystal display device has been described as an example of the electro-optical device of the present disclosure in the above description, the electro-optical device of the present disclosure is not limited to this. For example, the electro-optical device of the present disclosure may be applied to image sensors and the like.

What is claimed is:

1. An electro-optical device comprising:
a substrate;
a transistor including a semiconductor layer and a gate electrode, the semiconductor layer including a drain region to which a pixel potential is applied and extending in a first direction;
a scanning line electrically coupled to the gate electrode;
an insulating layer disposed between the scanning line and the gate electrode; and
a light-blocking part with a light-blocking property, wherein
the semiconductor layer, the gate electrode, the insulating layer, the scanning line are arranged in this order from the substrate,
the light-blocking part surrounds the semiconductor layer as viewed in the first direction,
the light-blocking part includes a first portion disposed at the insulating layer, and
the pixel potential is applied to the light-blocking part.

2. The electro-optical device according to claim 1, wherein
the semiconductor layer includes the drain region, a source region, a channel region located between the drain region and the source region in plan view, and a low-concentration drain region located between the drain region and the channel region in plan view and
the first portion overlaps the low-concentration drain region in plan view.

3. The electro-optical device according to claim 1, wherein
the light-blocking part includes two second portions extending from the first portion toward the substrate, the two second portions located on both sides of the semiconductor layer as viewed in the first direction, respectively.

4. The electro-optical device according to claim 1, wherein
the light-blocking part includes a third portion joined to the drain region.

5. The electro-optical device according to claim 3, wherein
the light-blocking part includes a third portion joined to the drain region and
the third portion extends from the first portion toward the substrate, is located between the two second portions as viewed in the first direction, and is joined to the two second portions.

6. The electro-optical device according to claim 1, wherein
the light-blocking part includes a fourth portion disposed between the substrate and the semiconductor layer.

7. The electro-optical device according to claim 1, further comprising:
a pixel electrode;
a pixel relay electrode; and
a coupling member, wherein
the transistor is provided corresponding to the pixel electrode,
the pixel relay electrode electrically couples the pixel electrode and the transistor, and
the coupling member is provided in a contact hole through which the pixel relay electrode and the pixel electrode are electrically coupled.

8. The electro-optical device according to claim 1, further comprising
a pixel electrode of the pixel potential, wherein
the semiconductor layer, the gate electrode, the insulating layer, the scanning line, and the pixel electrode are arranged in this order from the substrate.

9. The electro-optical device according to claim 1, wherein
the light-blocking part includes a portion joined to the semiconductor layer and
the light-blocking part has a proximal light-blocking structure in which a distance to the semiconductor layer is small.

10. An electronic apparatus comprising:
the electro-optical device according to claim 1; and
a control unit configured to control an operation of the electro-optical device.
